(19) United States
(12) Patent Application Publication
(10) Pub. No.: US 2019/0334263 A1
(43) Pub. Date: Oct. 31, 2019

(54) CONNECTOR AND THE CONDUCTING TERMINALS THEREOF

(71) Applicant: CHENG UEI PRECISION INDUSTRY CO., LTD., New Taipei City (TW)

(72) Inventors: SHENG-YUAN HUANG, New Taipei City (TW); HAN-WEI WANG, New Taipei City (TW); PEI-YI LIN, New Taipei City (TW); TE-HUNG YIN, New Taipei City (TW)

(21) Appl. No.: 16/369,221

(22) Filed: Mar. 29, 2019

(30) Foreign Application Priority Data
Apr. 27, 2018 (TW) 107205569

(51) Int. Cl. H01R 12/70; H01R 12/71; H01R 24/60; H01R 12/72; H01R 43/02; H01R 13/405

(52) U.S. Cl. CPC H01R 12/7005; H01R 12/716; H01R 24/60; H01R 2107/00; H01R 43/0256; H01R 13/405; H01R 12/721

(57) ABSTRACT

The present invention is a connector including a plurality of first terminals and second terminals. Each of the first terminals has a first securing portion, the first securing portion has a first contacting portion connected to a front end thereof. The first securing portion has a guiding portion extended downward from a rear end of the first securing portion. The guiding portion having an extending portion. The guiding portion has a first soldering portion extended downward from a bottom of the guiding portion. The first securing portion is arranged in a first upper guiding slot, the first contacting portion is arranged in a first terminal slot and extended into a plug slot, a bottom of the guiding portion is arranged in a first lower guiding slot, the first soldering portion is extended downward to go through a rear end of a bottom of a rear section.

### CROSS REFERENCE TO RELATED APPLICATION

The present application is based on, and claims priority from, Taiwan application number 107205569, filed Apr. 27, 2018, the disclosure of which is hereby incorporated by reference herein in its entirety.

### BACKGROUND OF THE INVENTION

### 1. Field of the Invention

This invention relates to an electronic connector and the conducting terminals thereof, particular to a connector and conducting terminals more stable and having better performance.

### 2. The Related Art

With the increasing of the request of internet and high-speed communication, the need of cloud computing and cloud storage are growing. For catering to the trend, the data transfer rate increases from 2.5 Gbps per channel, to 5 Gbps, 10 Gbps and even 28 Gbps in these days. Thus, the performance of connector also needs to be improved. From the printed circuit board to the conducting terminals, the impedance matching, the insertion loss, the return loss and the skew all must be considered.

Referring to FIG. 15 and FIG. 16, a conventional connector 100′ as a quad small form-factor pluggable (QSFP) connector consisted of an insulation body 10′, a plurality of first terminal 20′ and a plurality of second terminal 30′. The insulation body 10′ is formed in one-piece and having a plug slot 11′ disposed in the middle portion of the front end. The plug slot 11′ includes a plurality of first terminal slots 13′ which is disposed in line on the top wall of the plug slot 11′ and going through the top of the insulation body 10′, each of the first terminal slots 13′ extends backward to form a first upper terminal slot 131′ that goes through the back end of the insulation body 10′ and each of the first upper terminal slots 131′ extends downward to form a first fixing slot 132′. The insulation body 10′ has a rear section 14′ disposed at the rear and the rear section 14′ has a plurality of first lower guiding slots 141′ extended forward, and each of the first lower guiding slots 141′ has a notch 143′ extended upward to go through the rear section 14′.

Each of the first terminal 20′ has a first securing portion 21′ that connects to a first contacting portion 22′ at the front of the first securing portion 21′, and the first contacting portion 22 has a first elastic arm 221′ extended forward and downward from the front end of the first securing portion 21′. The first elastic arm 221′ has a first contacting arm 222′ extended upward and forward from the end of the first elastic arm 221′. The first securing portion 21′ has a guiding portion 24′ extended backward and downward from the bottom of the first securing portion 21′, and every two adjacent first terminals 20′ are separated with a gap (D′). The guiding portion 24′ has a first soldering portion 26′ extended downward and backward form the bottom of the guiding portion 24′. Each of the first securing portions 21′ is arranged in one of the first upper guiding slot 131′ and each of the first contacting portions 22′ is arranged in one of the first terminal slot 13′ to extend downward into the soldering slot 11′, the bottom section of the guiding portion 24′ is arranged in the first lower guiding slot 141′, the first soldering portion 26′ extends downward to go through the rear end of the rear section 14′.

Referring to FIG. 6 to FIG. 8, the diagrams illustrate the waveforms of impedance, insertion loss and return loss of the conventional connector 100′, and it shows the impedance of the conventional connector 100′ is beyond the specification standard (the range of the impedance of the receiver is from 90 ohm to 110 ohm) thus the high frequency performance of the conventional connector 100′ is not stable.

Therefore, it is necessary to provide a new connector structure to assure the impedance of the first terminal 20′ satisfied the specification standard and to improve the insertion loss and the return loss to achieve higher and more stable performance.

### SUMMARY OF THE INVENTION

The objective of the present invention is to provide a connector and conducting terminals thereof for improving the stability and the performance.

To achieve said objective, the connector in the present invention includes an insulation body and a plurality of conducting terminals. The insulation body has a plug slot extended backward from a middle of a front surface of the insulation body. The plug slot has a plurality of first terminal slots arranged in line and extended upward to go through a top of the insulation body. Each of the first terminal slots has a first upper terminal slot extended backward to go through a rear end of the insulation body. The first upper guiding slot has a first fixing slot extended downward. A bottom section of the insulation body is extended backward to form a rear section, the rear section has a plurality of first lower guiding slots extended forward from a rear surface of the rear section. The plurality of the conducting terminals have a plurality of first terminals. The plurality of the first terminals are arranged in line within the first terminal slots. Each of the first terminals has a first securing portion connected to a first contacting portion at a front end thereof and a first holding portion extended downward from a bottom of the first securing portion. The first securing portion has a guiding portion extended downward from a rear of the first securing portion. The guiding portion has an extending portion and a first soldering portion extended downward from a bottom of the guiding portion. The first securing portion is arranged within the first upper guiding slot, the first holding portion is secured in the first fixing slot, the first contacting portion is arranged in each of the first terminal slots to extended downward and fit into the plug slot, a bottom section of the guiding portion is arranged in each of the first lower guiding slots, the first soldering portion is extended downward to go through a rear bottom of the rear section.

As described above, the connector in this invention adds the extending portion on the guiding portion of the first terminal, and removes a notch shown in a conventional connector, so as to improve the stability and the performance in high-frequency transmission.

### BRIEF DESCRIPTION OF THE DRAWINGS

The present invention will be apparent to those skilled in the art by reading the following description, with reference to the attached drawings, in which:

FIG. 1 shows a perspective view of a connector of the present invention;

FIG. 2 shows an exploded view of the connector in a first embodiment as shown in FIG. 1;

FIG. 3 shows a sectional view of the connector in the first embodiment taken along line of FIG. 1;

FIG. 4 shows a sectional view of the connector in the first embodiment taken along line IV-IV of FIG. 1;

FIG. 5 shows a top view of the connector shown in FIG. 2;

FIG. 6 shows a comparison of impedance waveforms between the connector in the first embodiment and a conventional design;

FIG. 7 shows a comparison of insertion loss waveforms between the connector in the first embodiment and the conventional design;

FIG. 8 shows a comparison of return loss waveforms between the connector in the first embodiment and the conventional design;

FIG. 9 shows an exploded view of the connector in a second embodiment;

FIG. 10 shows a sectional view of the connector in the second embodiment taken along line of FIG. 1;

FIG. 11 shows a top view of the connector in the second embodiment shown in FIG. 1;

FIG. 12 shows a comparison of impedance waveforms between the connector in the second embodiment and the conventional design;

FIG. 13 shows a comparison of insertion loss waveforms between the connector in the second embodiment and the conventional design;

FIG. 14 shows a comparison of return loss waveforms between the connector in the second embodiment and the conventional design;

FIG. 15 shows a top view of the conventional connector;

FIG. 16 shows a sectional view of the conventional connector taken along line III′-III′.

### DETAILED DESCRIPTION OF THE PREFERRED EMBODIMENT

In order to describe the technical contents, structural features, purpose to be achieved and the effectiveness of the present invention, the detailed description is given with schema below.

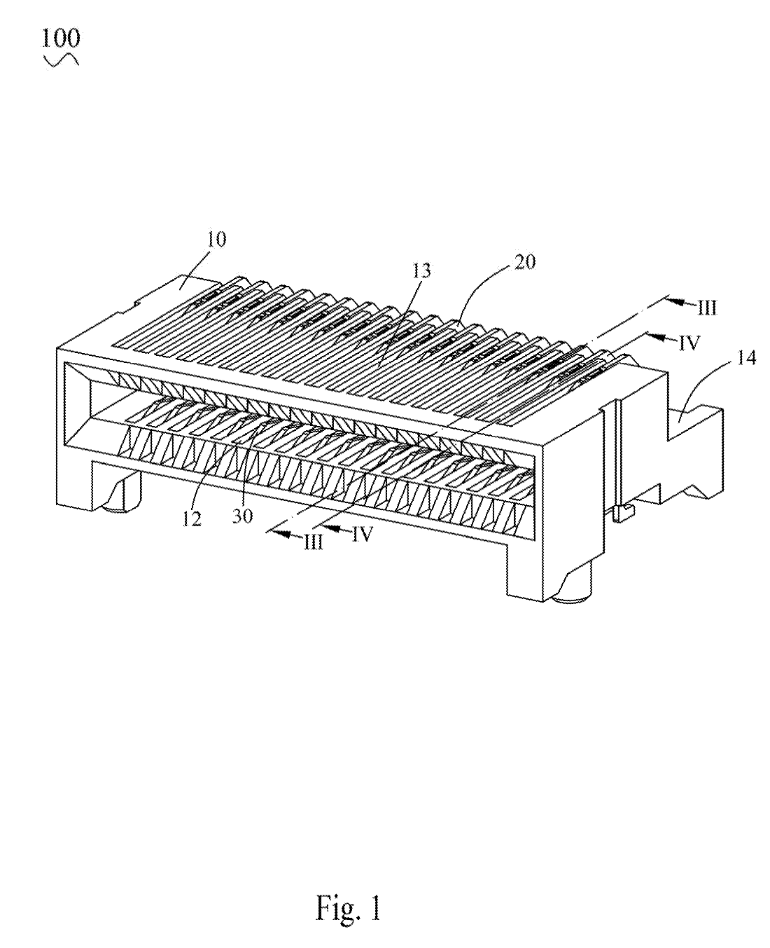

Referring to FIG. 1, the connector in the present invention is a quad small form-factor pluggable (QSFP) connector, and in this embodiment, the connector 100 includes an insulation body 10 and a plurality of conducting terminals which is consisted of a plurality of first terminals 20 and second terminals 30.

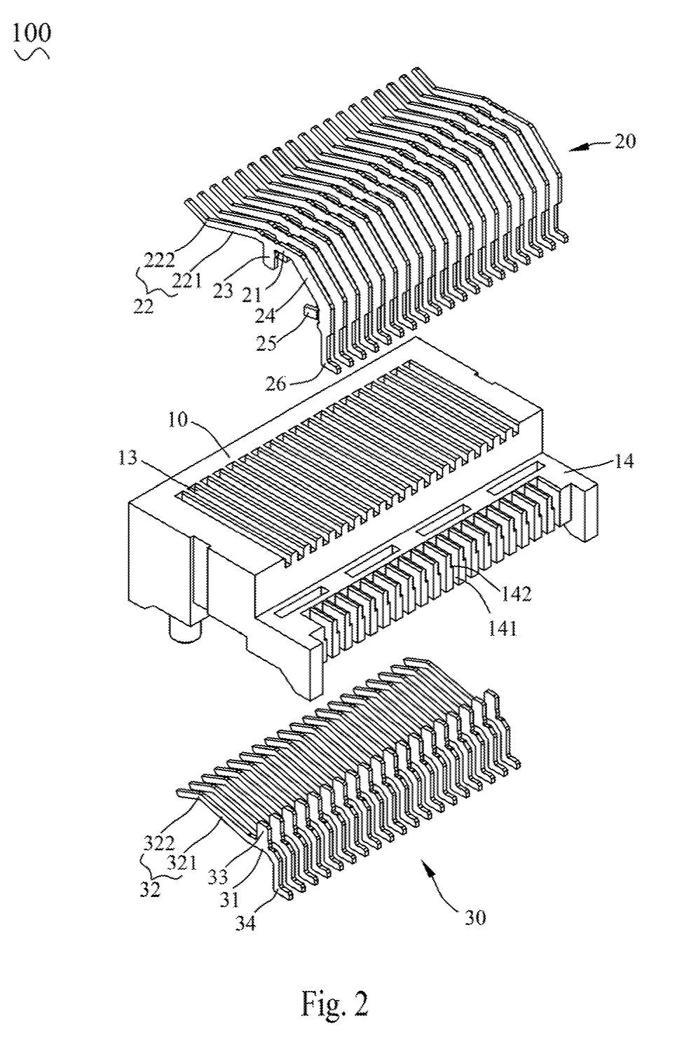

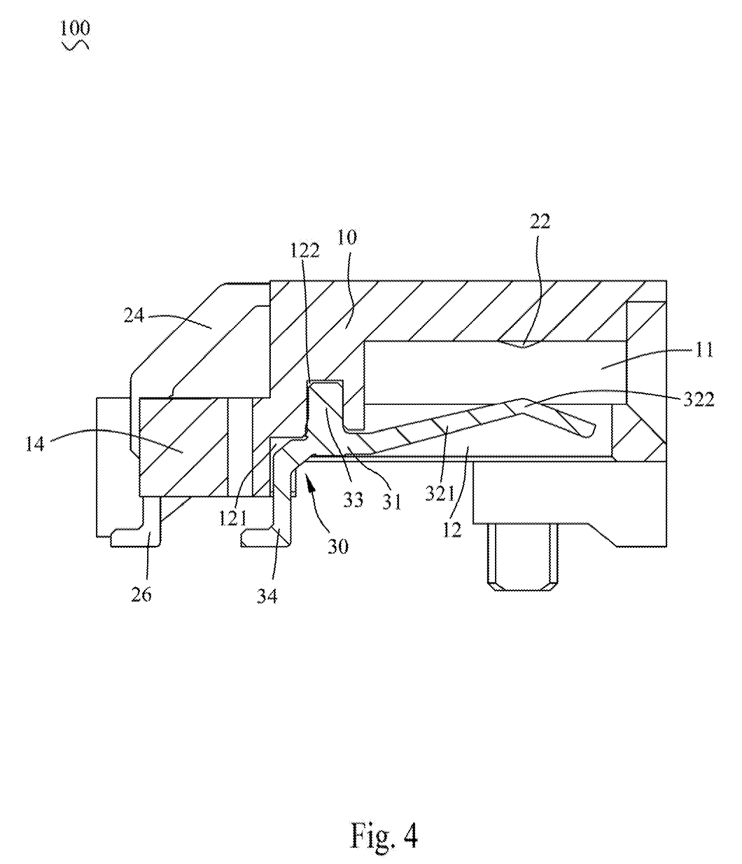

Referring to FIG. 2 to FIG. 5 that shows a first embodiment of the connector 100, the insulation body 10 is formed in one-piece and has a plug slot 11 extended from a middle of a front surface of the insulation body 10, the plug slot 11 has a plurality of second terminal slots 12 arranged in line and extended downward from a bottom wall of the plug slot 11, each of the second terminal slots 12 has a second guiding slot 121 extended backward and downward to go through a bottom of the insulation body 10, the second guiding slot 121 has a second fixing slot 122 extended upward from the second guiding slot 121. The plug slot 11 has a plurality of first terminal slots 13 arranged in line and extended upward to go through a top of the insulation body 10, the first terminal slot 13 has a first upper guiding slot 131 extended backward to go through a rear end of the insulation body 10. The first upper guiding slot 131 has a first fixing slot 132 extended downward from the first upper guiding slot 131, the insulation body 10 has a rear section 14 extended backward from a bottom of a rear surface of the insulation body 10, and the rear section 14 has a plurality of first lower guiding slots 141 extended forward from a rear surface of the rear section 14, the first lower guiding slot 141 has a containing slot 142 extended laterally from an upper section of the first lower guiding slot 141. The rear section 14 in the present invention has no notches 143′ shown in the conventional design. Therefore side-walls of the first lower guiding slots 141 is higher than side-walls of the first lower guiding slots 141′ shown in the conventional design.

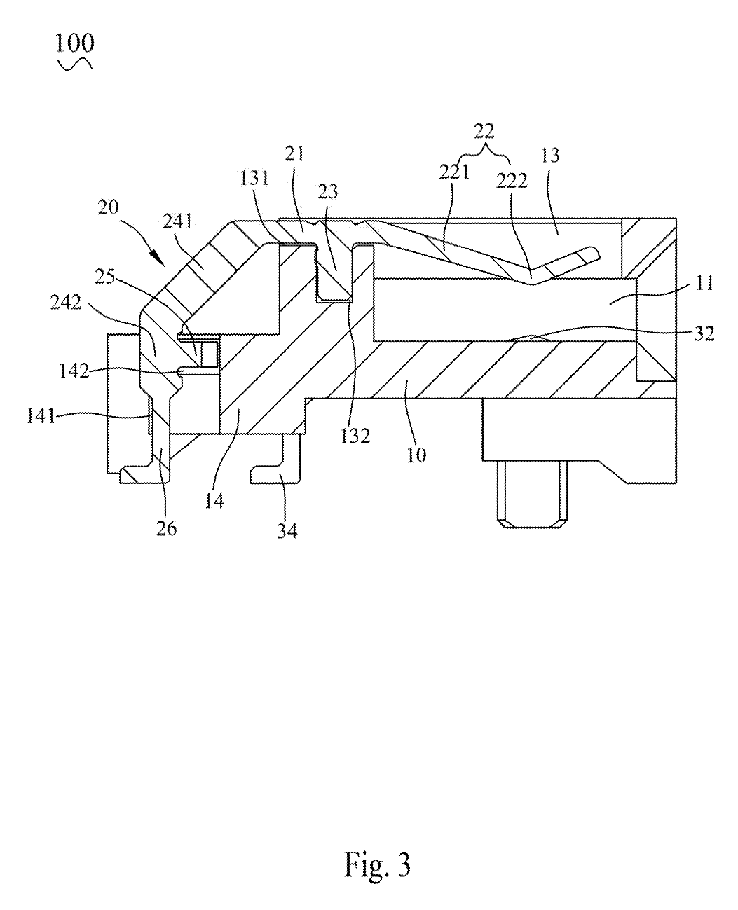

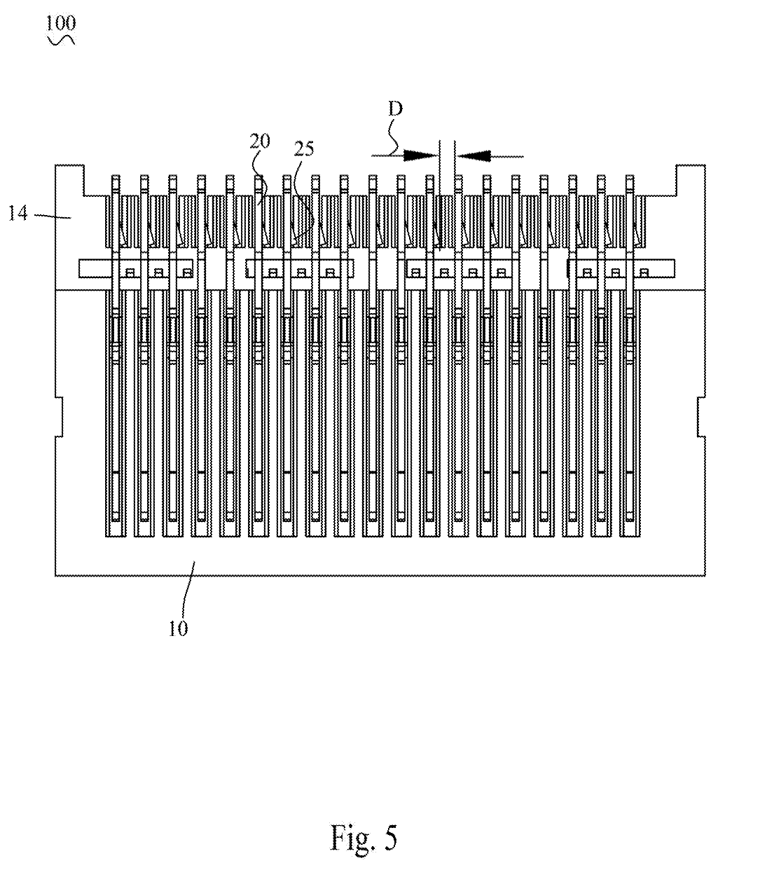

Referring to FIG. 2, FIG. 3 and FIG. 5, each of the plurality of the first terminals 20 has a first securing portion 21, a front end of the first securing portion 21 connects to a first contacting portion 22, the first contacting portion 22 has a first elastic arm 221 extended forward and downward from the front end of the first securing portion 21, the first elastic arm 221 has a first contacting arm 222 extended forward and upward from an end of the first elastic arm 221. The first securing portion 21 has a first holding portion 23 extended downward from a bottom of the first securing portion 21, the first securing portion 21 has a guiding portion 24 extended backward and downward from a rear end of the first securing portion 21, the guiding portion 24 has a ramp portion 241 extended downward and backward from the rear end of the first securing portion 21, and a vertical portion 242 extended downward from a bottom of the ramp portion 241. The vertical portion 242 has an extending portion 25. In the first embodiment of the present invention, the extending portion 25 is extended from a front end of the vertical portion 242 and bent laterally, a front end of the extending portion 25 and an adjacent first terminal 20 arranged closest to the front end of the extending portion are separated with a gap (D). The guiding portion 24 has a first soldering portion 26 extended downward and backward from a bottom of the guiding portion 24. The plurality of the first terminals 20 are arranged in the first terminal slots 13. To be specific, each of the first securing portions 21 is arranged in the first upper guiding slot 131, the first holding portion 23 is secured in the first fixing slot 132, the first contacting portion 22 is arranged in the first terminal slot 13 to extend into the plug slot 11, the vertical portion 242 is arranged in the first lower guiding slot 141, the extending portion 25 is arranged in the containing slot 142, the first soldering portion 26 is extended downward to go through a rear end of a bottom of the rear section 14.

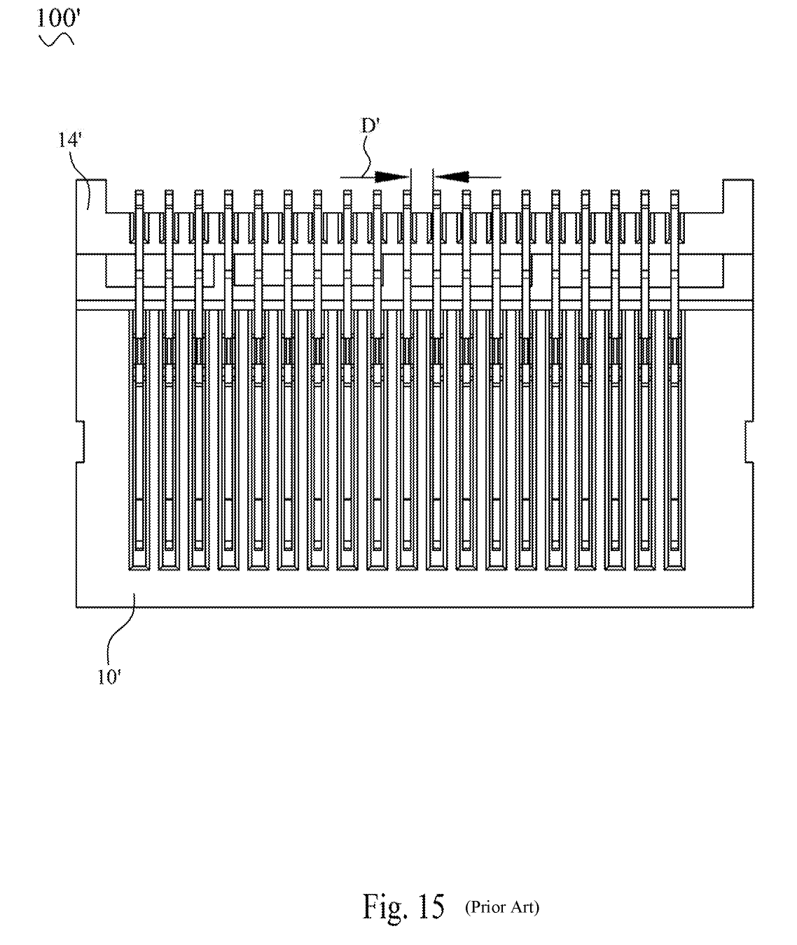

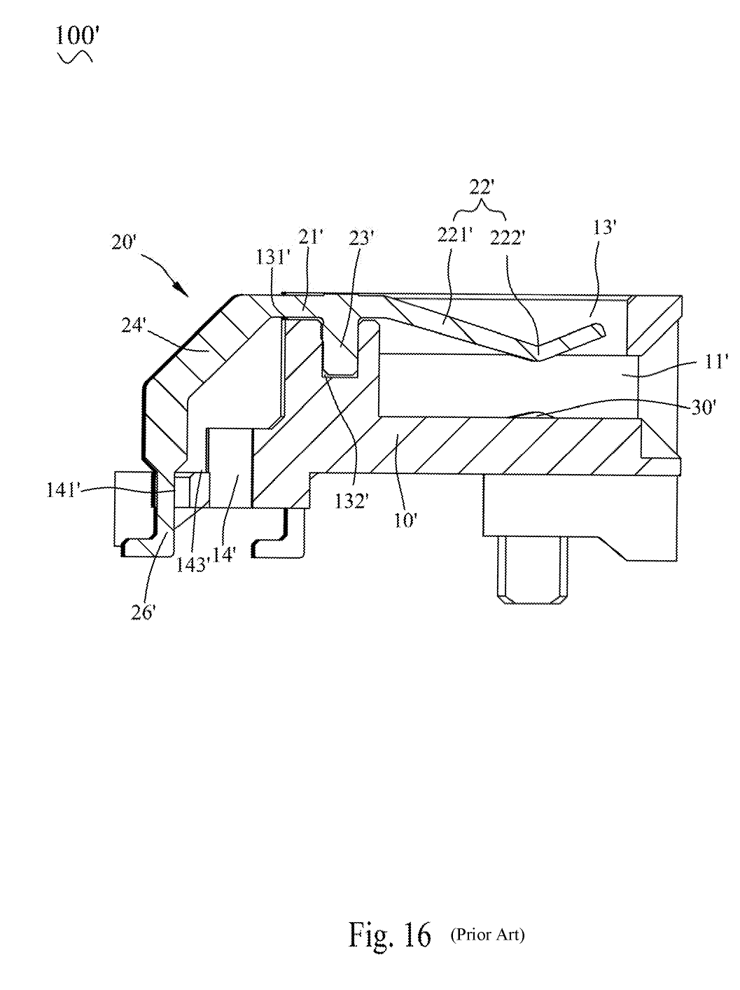

Referring to FIG. 5, FIG. 15 and FIG. 16, the gap (D) is narrower than the gap (D′) shown in the conventional design, thus two adjacent the first terminals 20 might contact with each other and effect the insulation resistance and cause the connector 100 unstable. To solve it, the notch 143′ in the conventional design is filled to prevent two adjacent the first terminals 20 from contacting with each other in order to stabilize the insulation resistance of the first terminals 20. Therefore side-walls of the first lower guiding slots 141 is higher than side-walls of the first lower guiding slots 141′ shown in the conventional design.

Referring to FIG. 2 to FIG. 4 now, the plurality of the second terminal 30 are arranged in the second terminal slots 12, each of the plurality of the second terminals 30 has a second securing portion 31, the second securing portion 31 is connected to a second contacting portion 32 at a front of the second securing portion 31, the second contacting portion 32 has a second elastic arm 321 extended forward and upward from a front end of the second securing portion 31, the second elastic arm 321 has a second contacting arm 322 extended forward and downward from an end of the second elastic arm 321, the second securing portion 31 has a second holding portion 33 extended upward from the second securing portion 31, the second securing portion 31 has a second soldering portion 34 extended downward and backward from a rear end of the second securing portion 31. The second securing portion 31 is arranged in the second guiding slot 121, the second holding portion 33 is secured in the second fixing slot 122, the second contacting portion 32 is arranged in the second terminal slot 12 and extended upward into the plug slot 11, the second soldering portion 34 is extended downward to go through a front of the bottom of the rear section 14.

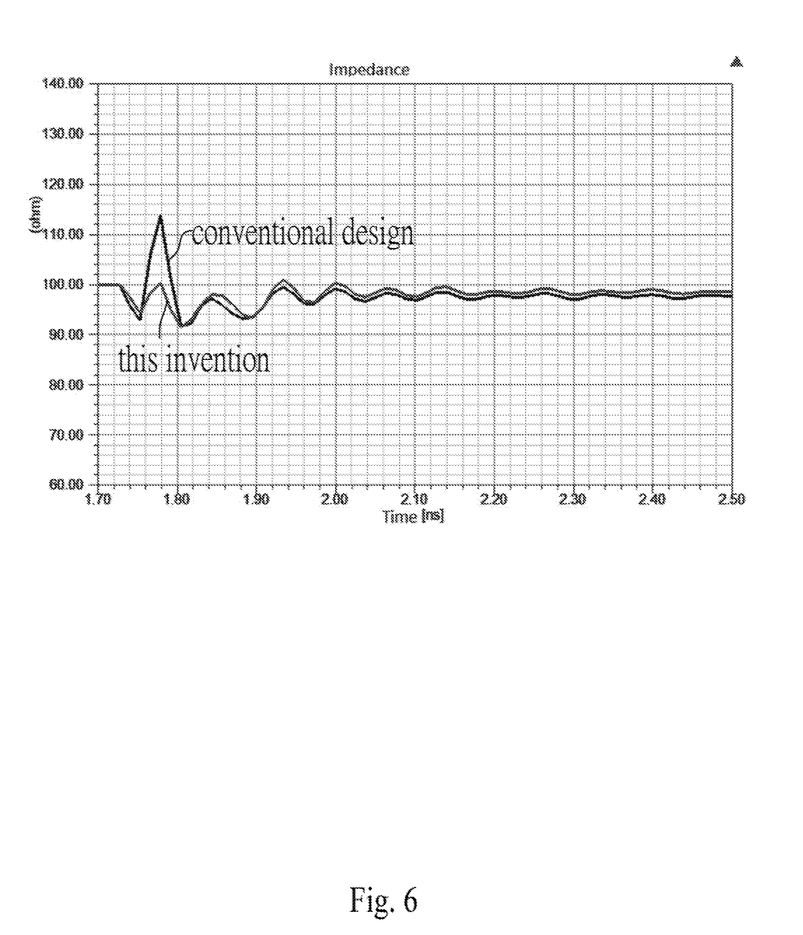

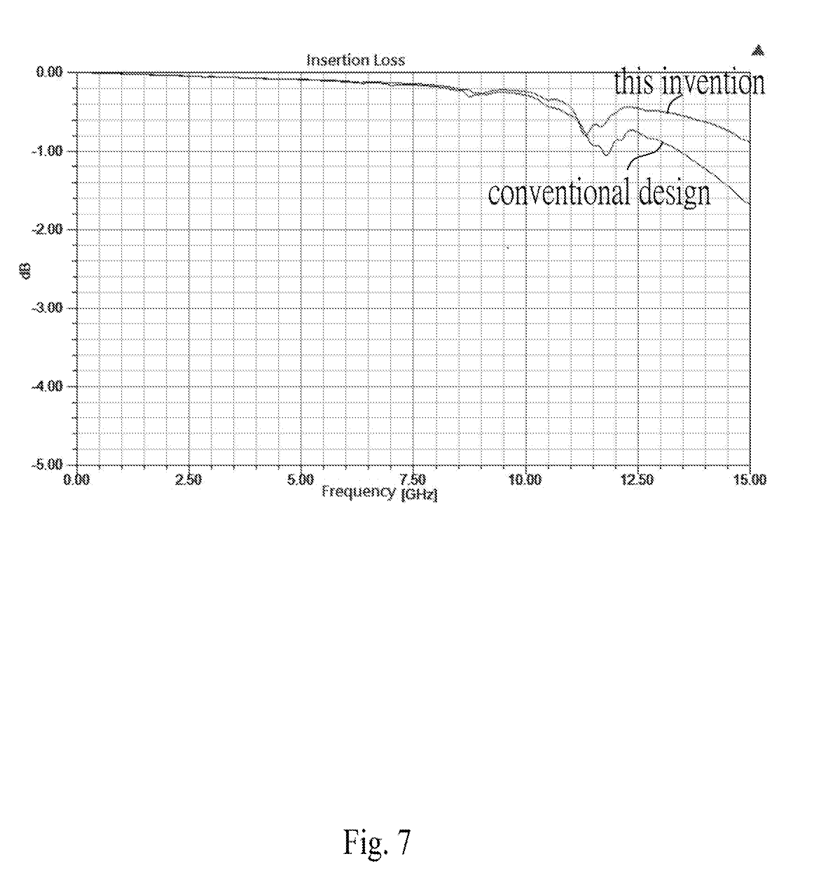

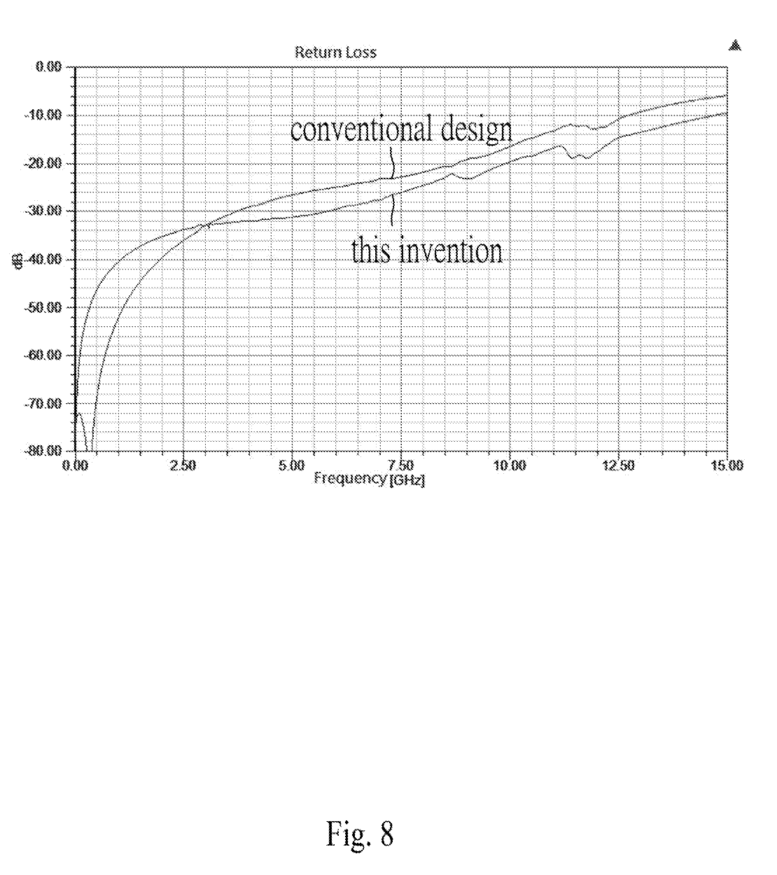

Referring to FIG. 6 to FIG. 8, these tow diagrams show the simulation results of impedance waveform, insertion loss and the return loss waveform of the first terminals 20 of the first embodiment. In comparison of the conventional design, a range of impedance of the first terminals 20 is from 90 ohm to 100 ohm of which difference is less than 10 ohms, which satisfies the standard of QSFP connector. Besides, the insertion loss and the return loss are also less than the conventional design. Which means the signal attenuation is less, and the reflection between the transmitter and the receiver is lower during signal transmission, thus the interference can be reduced and the performance can be improved.

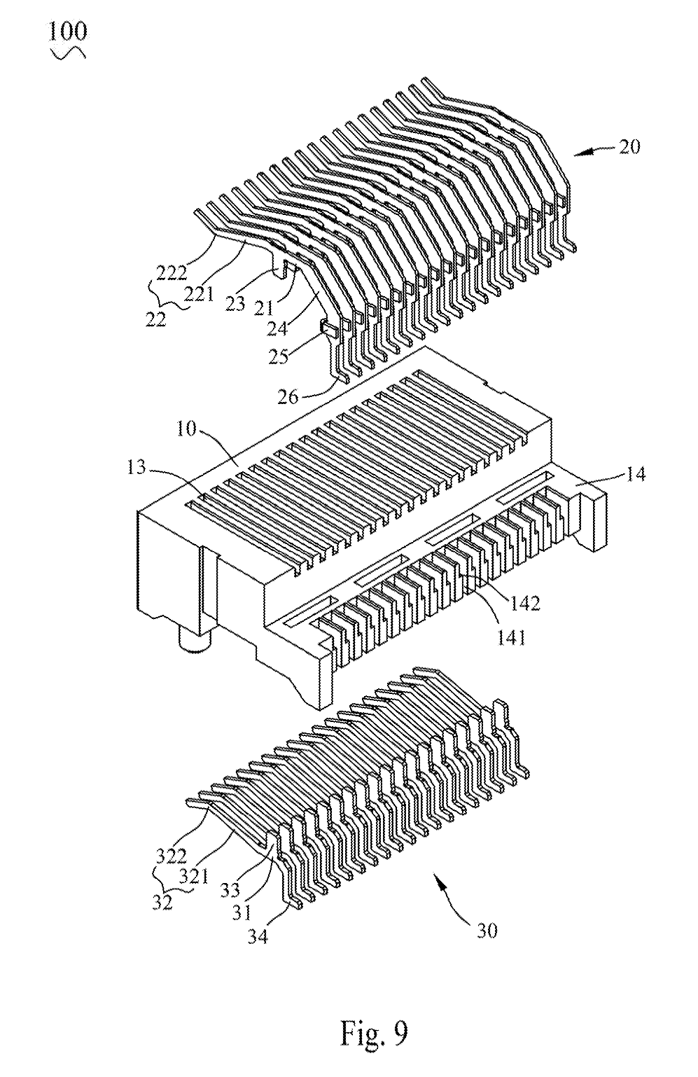

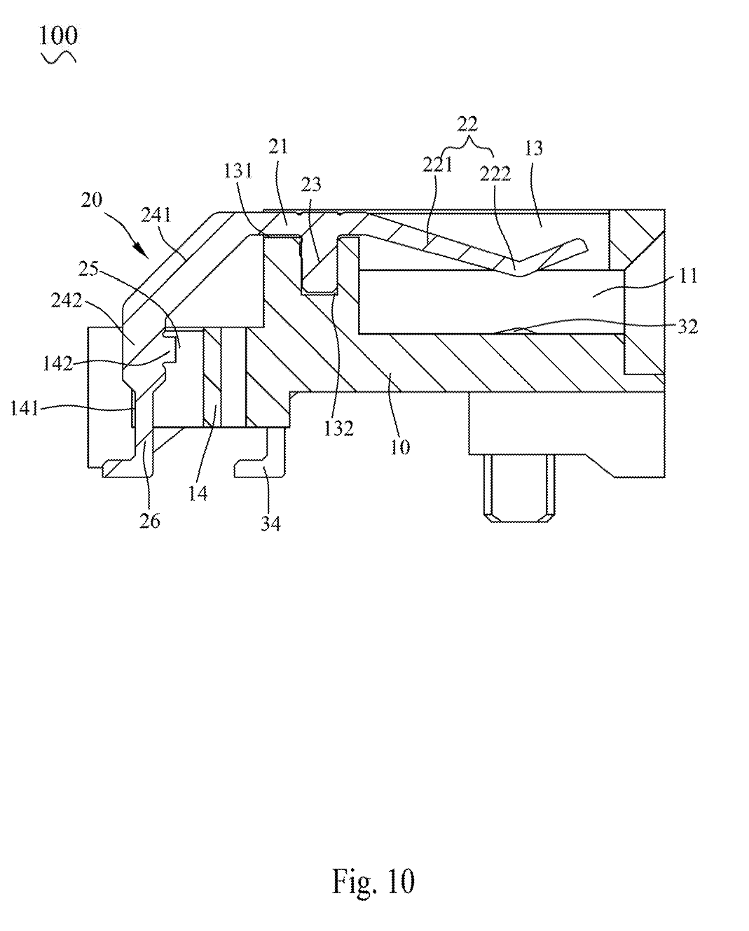

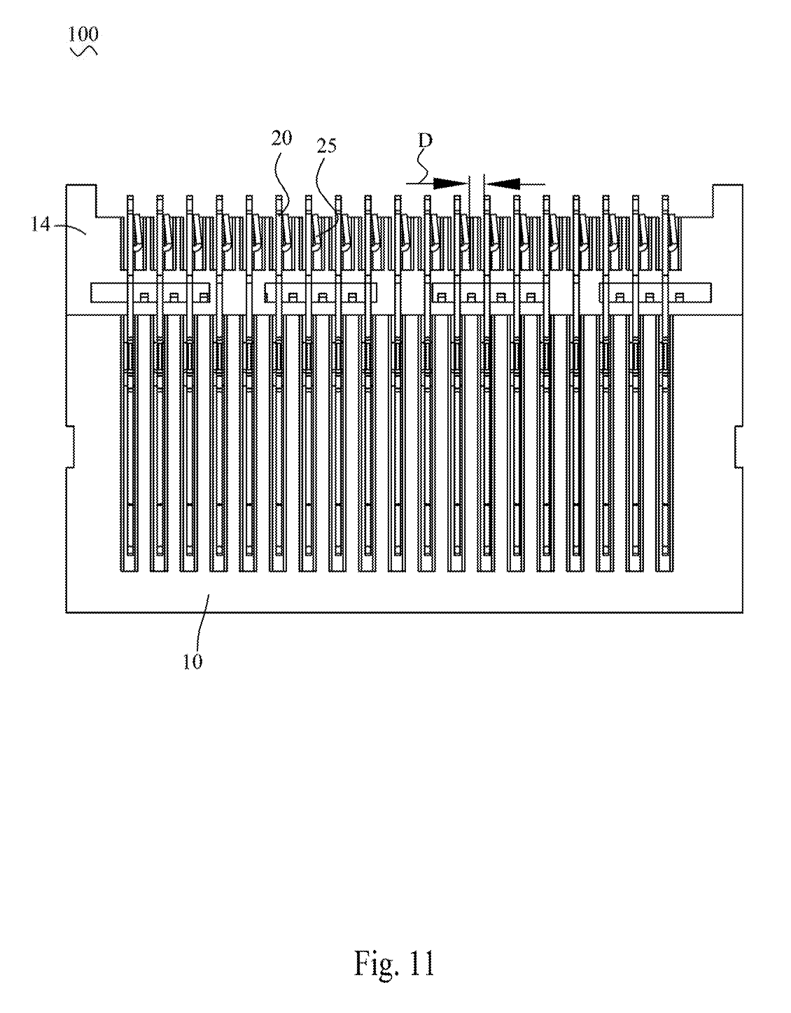

Referring to FIG. 9 to FIG. 11 now, the connector in the second embodiment is largely similar to the connector in the first embodiment, the only difference is that the extending portion 25 is extended backward from the front end of the vertical portion 242 to form a side portion facing a side surface of the vertical portion 242, an outer surface of the side portion 25 and adjacent the first terminal 20 arranged closest to the side portion 25 is separated with a gap (D), the gap (D) is narrower than the gap (D′) in the conventional design.

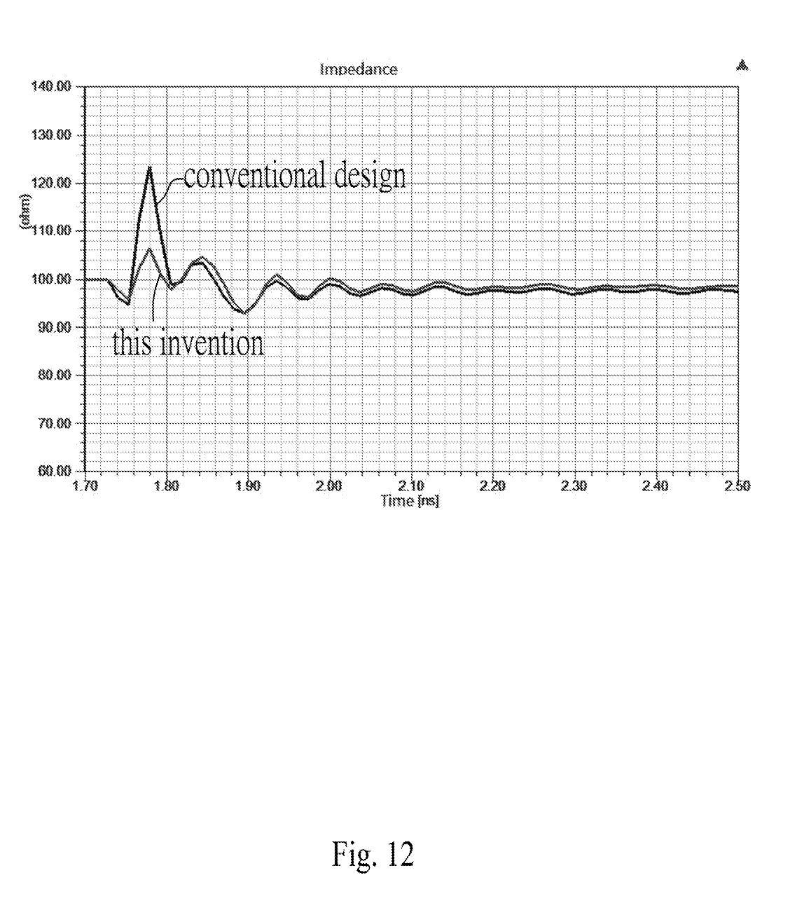

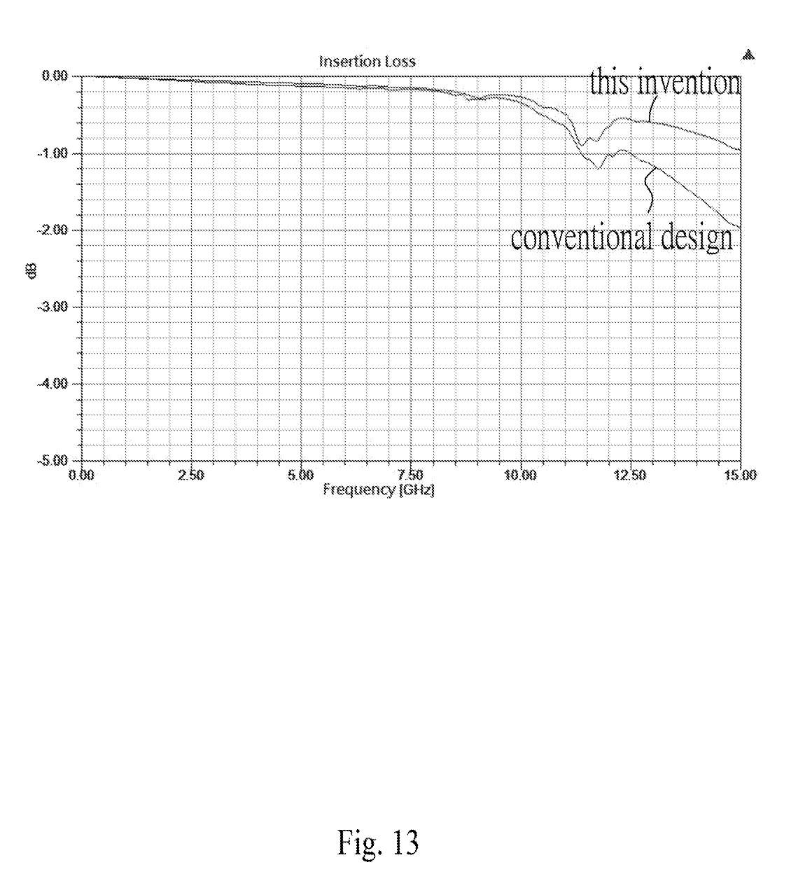

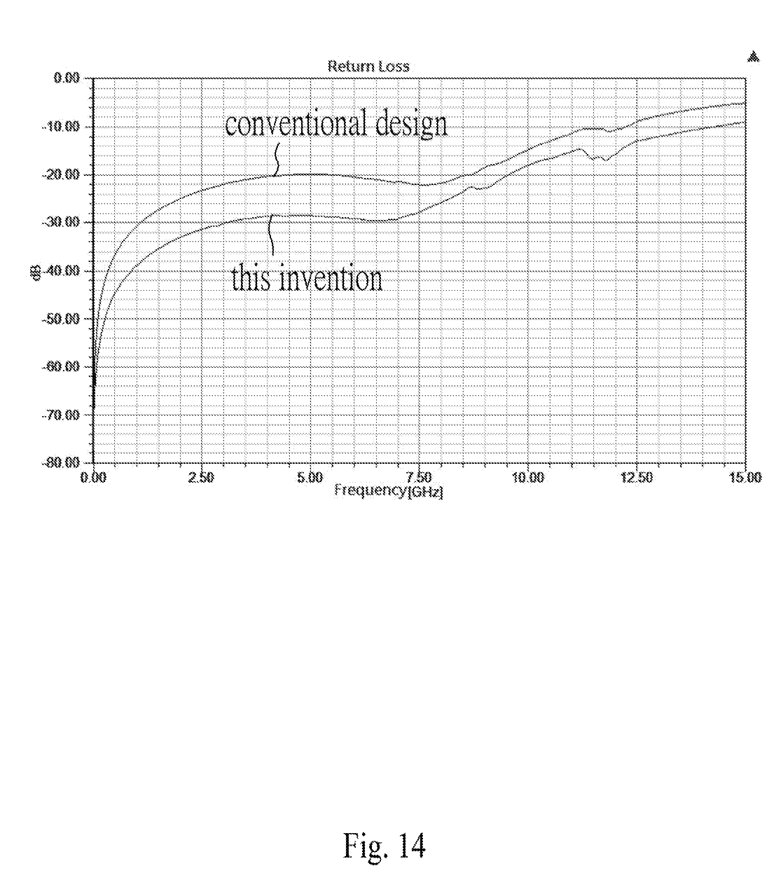

Referring to FIG. 12 to FIG. 14, the diagrams illustrate the waveforms of impedance, insertion loss and return loss of the first terminals 20 of the second embodiment in the present invention, in comparing with the conventional design, and it shows the impedance of the first terminals 20 in the second embodiment satisfies the specification standard of QSFP connector (a range of the impedance is from 96 ohm to 106 ohm of which difference is less than 10 ohm). Besides, the insert loss and the return loss are also less than the conventional design. Which means the signal attenuation during signal transmission is less, and the reflect signal from the transmitter and receiver is also less, so the total signal interference is less and the performance of the connector is better.

As described above, the connector 100 in the present invention has the extending portion 25 on the guiding portion 24 of the first terminal 20, the extending portion 25 increases the thickness of the guiding portion 24 and shorten the gap D two adjacent the first terminals 20. In order to prevent the insulation resistance and the dielectric withstanding voltage from decreasing with the gap D between the adjacent first terminals 20, the notches 143′ on the rear section 14′ of the insulation body 10′ in the conventional design are filled to increase the height of the side-walls of the first lower guiding slots 141. And the simulation result shows that the impedance of the first terminals 20 with this new design satisfies the specification standard of QSFP connector, and the insertion loss and the return loss can also be improved so as to enhance the stability and the performance of the connector 100 in this invention in high frequency transmission.

What is claimed is:

1. A connector comprising:
an insulation body, the insulation body having a plug slot extended backward from a middle of a front surface of the insulation body, a plurality of first terminal slots disposed in line on a top wall of the plug slot and going through a top of the insulation body, a first upper guiding slot extended backward from a rear end of each of the first terminal slots to go through a rear end of the insulation body, a first fixing slot extended downward from the first upper guiding slot, a rear section extended backward from a bottom of a rear surface of the insulation body, a plurality of first lower guiding slots extended forward from a rear surface of the rear section; and
a plurality of first terminals being arranged in the first terminal slots, each of the plurality of the first terminals having a first securing portion connecting to a first contacting portion disposed at a front of the first securing portion, a first holding portion extended downward from a bottom of the first securing portion, a guiding portion extended downward from a rear end of the first securing portion, a extending portion extended from a front edge of the guiding portion, a first soldering portion extended from a bottom of the guiding portion, the first securing portion being positioned in the first upper guiding slot, the first holding portion being secured in the first fixing slot, the first contacting portion being arranged in each of the first terminal slots and extended downward into the plug slot, the bottom of the guiding portion being arranged in each of the first lower guiding slots, the first soldering portion being extended downward to go through a rear end of a bottom of the rear section, the extending portion being facing a side-wall of each of the first lower guiding slots.

2. The connector as claimed in claim 1, wherein the plug slot has a plurality of second terminal slots disposed in line and extended downward from a bottom of the plug slot, and a plurality of second terminals disposed in the second terminal slots to extended upward into the plug slot.

3. The connector as claimed in claim 2, wherein each of the plurality of second terminal slots communicates with a second guiding slot extended backward and downward to go through a bottom of the insulation body, each of the plurality of second terminals has a second securing portion, a second contacting portion connected to a front end of the second securing portion, and a second soldering portion extended downward and backward from a rear end of the second securing portion, the second securing portion is positioned in the second guiding slot, the second contacting portion is disposed in each of the second terminal slots to extend upward into the plug slot, the second soldering portion is extended downward to go through a front end of the bottom of the rear section.

4. The connector as claimed in claim 3, wherein the second guiding slot communicates with a second fixing slot extended upward from the second guiding slot, the second securing portion connects to a second holding portion extended upward from the second securing portion, the second holding portion is secured in the second fixing slot.

5. The connector as claimed in claim 3, wherein the second contacting portion has a second elastic arm extended upward and forward from the front end of the second securing portion, and a second contacting arm bent forward and downward from an end of the second elastic arm.

6. The connector as claimed in claim 1, wherein each of the first lower guiding slots has a containing slot extended laterally from an upper portion thereof, the extending portion is arranged in the containing slot.

7. The connector as claimed in claim 1, wherein the first contacting portion has a first elastic arm extended forward and downward from the front end of the first securing portion, and a first contacting arm extended forward and upward from an end of the first elastic arm.

8. The connector as claimed in claim 1, wherein the guiding portion has a ramp portion extended backward and downward from the rear end of the first securing portion and a vertical portion extended downward from a bottom of the ramp portion, the vertical portion is arranged in each of the first lower guiding slots, the extending portion is formed by extending forward and bent laterally from a front edge of the vertical portion.

9. The connector as claimed in claim 1, wherein the guiding portion has a ramp portion extended backward and downward from the rear end of the first securing portion and a vertical portion extended downward from a bottom of the ramp portion, the vertical portion is arranged in each of the first lower guiding slots, the extending portion is formed by extending forward and bent laterally and backward from a front edge of the vertical portion, a side surface of the extending portion is faced with a side surface of the vertical portion.

10. A conducting terminal secured in a connector, comprising a first securing portion; a first contacting portion connected to a front end of the first securing portion, a first guiding portion extended downward from a rear end of the first securing portion, an extending portion extended laterally from a front edge of the first guiding portion, a first soldering portion extending from a bottom of the first guiding portion.

11. The conducting terminal as claimed in claim 10, wherein the first contacting portion has a first elastic arm extended forward and downward from the front end of the first securing portion, and a first contacting arm extended forward and upward from an end of the first elastic arm.

12. The conducting terminal as claimed in claim 10, wherein the guiding portion has a ramp portion extended backward and downward from the rear end of the first securing portion and a vertical portion extended downward from a bottom of the ramp portion, the vertical portion is arranged in a first lower guiding slot of the connector, the extending portion is formed by extending forward and bent laterally from a front edge of the vertical portion.

13. The conducting terminal as claimed in claim 10, wherein the guiding portion has a ramp portion extended backward and downward from the rear end of the first securing portion and a vertical portion extended downward from a bottom of the ramp portion, the vertical portion is arranged in a first lower guiding slot of the connector, the extending portion is formed by extending forward and bent laterally and backward from a front edge of the vertical portion, a side surface of the extending portion is faced with a side surface of the vertical portion.
